(19) United States
(12) Patent Application Publication
(10) Pub. No.: US 2021/0342837 A1
(43) Pub. Date: Nov. 4, 2021

(54) TEMPLATE BASED MULTI-PARTY PROCESS MANAGEMENT

(71) Applicant: International Business Machines Corporation, Armonk, NY (US)

(72) Inventors: Jim Chun-ta CHEN, Rochester, MN (US); Brittany Duffy, Rochester, MN (US); Sophie Keith, Rochester, MN (US); Jocelyne Beatrice Renault, Rochester, MN (US)

(73) Assignee: International Business Machines Corporation, Armonk, NY (US)

(21) Appl. No.: 16/861,839

(22) Filed: Apr. 29, 2020

(51) Int. Cl. G06Q 20/40; G06F 40/30; G06Q 20/38

(52) U.S. Cl. CPC G06Q 20/405; G06Q 20/388; G06F 40/30

(57) ABSTRACT

From a first group of records of a set of transactions, a set of common transactions is extracted. The first group is formed based on a criterion. A record corresponds to a transaction in the set of transactions. A first transaction in the set of common transactions is classified into a transaction type. From a first actor associated with the first transaction, a first role corresponding to the first transaction is determined. Using the transaction type, the first role, and the time period, a transaction template, the transaction template comprising an action item and a role corresponding to the action item are determined. Using the first transaction template, a transaction is instantiated, the instantiating generating an action request corresponding to the action item and assigning an actor to the role.

### BACKGROUND

The present invention relates generally to a method, system, and computer program product for process templating. More particularly, the present invention relates to a method, system, and computer program product for template based multi-party process management.

Many business processes involve multiple parties, from two or more entities. Such multi-party processes are often required when implementing regulatory processes, compliance processes and certifications that a process has been properly followed or completed, for example for data protection in particular jurisdictions or for particular types of data. For example, Company A might be subject to a data privacy scheme, such as the General Data Protection Regulation (GDPR) scheme in the European Union, the California Consumer Privacy Act (CCPA) in California, or the requirements of the Health Insurance Portability and Accountability Act (HIPAA) for health-related data in the United States. If Company A uses Vendor B for data-related services subject to a data protection scheme, Company A might require that Vendor B also be compliant with that scheme, at least as relating to Company A's data. Data protection compliance processes are only one example of a multi-party process, and many others exist.

Implementing and certifying compliance with a multi-party process often requires multiple steps, including certifications that an implementation conforms to a requirement or that a task has been performed, as well as performing actual tasks. For example, one sequence might include Customer A requesting a certification from Vendor B, Vendor B responding with a proposal for completing the work required to implement the certification, Customer A approving the proposal, Customer A performing a task and Vendor B approving the performance, Vendor B performing a task and Customer A approving the performance, and more. The necessary tasks and certifications, and the roles of those responsible for performing such tasks and certifications, often vary from entity to entity and from implementation to implementation, resisting standardization and automation.

### SUMMARY

The illustrative embodiments provide a method, system, and computer program product. An embodiment includes a method that extracts, from a first group of records of a set of transactions, a set of common transactions, the first group formed based on a criterion, a record corresponding to a transaction in the set of transactions. An embodiment classifies a first transaction in the set of common transactions into a transaction type. An embodiment determines, from a first actor associated with the first transaction, a first role corresponding to the first transaction. An embodiment generates, using the transaction type, the first role, and the time period, a transaction template, the transaction template comprising an action item and a role corresponding to the action item. An embodiment instantiates, using the first transaction template, a transaction, the instantiating generating an action request corresponding to the action item and assigning an actor to the role.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for template based multi-party process management in accordance with an illustrative embodiment;

FIG. 4 depicts a block diagram of an example configuration for template based multi-party process management in accordance with an illustrative embodiment;

FIG. 5 depicts an example of template based multi-party process management in accordance with an illustrative embodiment;

FIG. 6 depicts a continued example of template based multi-party process management in accordance with an illustrative embodiment;

FIG. 7 depicts a flowchart of an example process for template based multi-party process management in accordance with an illustrative embodiment;

FIG. 8 depicts a flowchart of an example process for template based multi-party process management in accordance with an illustrative embodiment;

FIG. 9 depicts a cloud computing environment according to an embodiment of the present invention; and

FIG. 10 depicts abstraction model layers according to an embodiment of the present invention.

### DETAILED DESCRIPTION

The illustrative embodiments recognize that implementations of multi-party processes are not standard. Often such a process is performed once between two particular parties, without an expectation that a similar process will need to be performed again. Even if a vendor with multiple customers implements a standard process internally, that process must be adapted to interface with the internal processes of each different customer. Further, even internally, different divisions of an entity might require different processes. For example, a division dealing with personal health care data might have different data protection requirements from a division dealing with logistics data, necessitating different data protection compliance processes.

The illustrative embodiments also recognize that the roles of those who are responsible for performing tasks or certifications in a multi-party process are also not standard. For example, at one company a data center director might be responsible for implementing all multi-party processes related to data protection compliance, while at another company such responsibilities might be split among several data center directors and the company's Chief Information Officer (CIO). In addition, a party in a multi-party process might not have someone assigned to be responsible for performing the necessary tasks or certifications, might not realize that someone needs to be assigned, or might not realize that the lack of such assignment is delaying other parts of the process.

The illustrative embodiments also recognize that a party might be pursuing multiple processes, at multiple stages, with the same counterparty. For example, two parties might be performing a data protection compliance process for both Product A and Product B, but because the products are different, different process steps and different responsibilities for those steps might be necessary. Confusion between processes can also lead to implementation delays.

Thus, the illustrative embodiments recognize that there is an unmet need to standardize multi-party processes, and the roles needed to implement such standardized processes. In addition, standardization allows for process improvement, using lessons learned from previous implementations of a process, and implementation of new processes using portions of previous processes.

The illustrative embodiments recognize that the presently available tools or solutions do not address these needs or provide adequate solutions for these needs. The illustrative embodiments used to describe the invention generally address and solve the above-described problems and other problems related to template based multi-party process management.

An embodiment can be implemented as a software application. The application implementing an embodiment can be configured as a modification of an existing process management system, as a separate application that operates in conjunction with an existing process management system, a standalone application, or some combination thereof.

Particularly, some illustrative embodiments provide a method that analyzes data of a set of transactions to generate a transaction template, and uses the transaction template to instantiate a transaction including an action request.

A transaction is an exchange of information between one party and another. One type of transaction is a request—for example, that a task be performed or a certification signed. Another type of transaction is a report—for example, that a task has been performed, or the provision of a certification. Other types of transactions are also possible and contemplated within the scope of the illustrative embodiments. In addition, a request need not precede a report, and a report need not be a response to a specific request. The information in a transaction can be exchanged using any suitable technique, including by email or using a social media platform, entering information into a website or application, and others.

An embodiment maintains records of transactions. If the records are not received already in chronological order (i.e. a record with an earlier timestamp comes before a record with a later timestamp), an embodiment rearranges the records into chronological order based on data within the transaction records. One embodiment records transactions in a transaction log implemented in one location. Another embodiment records transactions in a transaction log implemented in more than one location—also referred to as a distributed transaction log or distributed ledger. In one embodiment, a distributed ledger is implemented using a blockchain. A blockchain is a cryptographically-linked list of records, also called blocks. For use as a distributed ledger, a blockchain is typically managed by a peer-to-peer network collectively adhering to a protocol for inter-network communication and validating new blocks. Data stored using a blockchain is resistant to modification because, once recorded, the data in any given block cannot be altered retroactively without alteration of all subsequent blocks, which requires consensus of a majority of the network. In one non-limiting blockchain implementation, each block contains a cryptographic hash of the previous block, a timestamp, and transaction data. Another embodiment does not maintain transaction records, but receives transaction records from another source.

An embodiment forms chains of transaction records, arranged in time order, into groups based on a possible relationship between individual transactions or transaction chains in the group. One non-limiting example of a transaction group is a request (e.g. that a task be performed) followed by a report (e.g. that the task has been performed).

One embodiment groups transaction records based on the parties, or the types of parties, involved, because it is possible that multiple transactions between the same parties or similar parties are related to each other. For example, records of transactions between a vendor and Company A would be placed in one group, and records of transactions between the vendor and Company B would be placed in another group.

Another embodiment groups transaction records based on a description associated with the transaction records. Non-limiting examples of a description associated with the transaction records include a subject field in an email, a file system folder name, a project name associated with transactions exchanged via a website or application, and a description tag maintained as part of a transaction record. A human expert can also apply a description to a transaction record. For example, a human expert might label one or more transaction records with a label such as “GDPR implementation” or “HIPAA compliance”.

Another embodiment groups transaction records based on time elapsed between transactions, because that transactions that occur within a time elapsed below a threshold are more likely to be related to each other than transactions that do not occur within a time elapsed below the threshold. For example, consider a set of transaction records including four transactions on the same day, followed by another two transactions on the same day a month later. Here, it is likely that the four transactions that occurred on the same day were related to each other, and the two transactions a month later were also related to each other, but the two groups of transactions are less likely to be related to each other because of the monthlong gap between the groups.

Another embodiment groups transaction records based on an indication that records in a transaction chain are ready for templating. Some non-limiting examples of indications that a chain is ready for templating include when a transaction marked as the final step in a process occurs, when a user indicates that a process implemented using the transaction chain has completed, and when a user indicates that a group of records constitute a transaction chain that is ready for templating.

Another embodiment groups transaction records based on another criterion. Another embodiment groups transaction records based on a combination of criteria.

An embodiment analyzes a group of transaction chains to generate a transaction template. A transaction template includes one or more action items, and one or more placeholders for additional data corresponding to each action item. Thus, a transaction template is, in effect, a blank form that includes placeholders in the place of actual data. One placeholder is the role of the person or entity associated with the action item. For example, if an action item is a request for a signature, the role is a placeholder for the person or entity who will provide the requested signature. As another example, if an action item is a report, the role is a placeholder for the person or entity who will receive the report. Another placeholder is a time period associated with the transaction type, i.e. how long that transaction type is expected to take.

To begin generating a transaction template, an embodiment compares transaction chains in the group to each other and extracts a set of common transactions. For example, some common transactions might be a request for an electronic signature followed by a report providing an electronic signature.

Using the set of common transactions, if a transaction is not already classified into a transaction type, an embodiment classifies the transaction into a transaction type and uses the transaction type as the action item. Some non-limiting examples of action items are broad (e.g., report), while others are narrower (e.g. initial proposal, final work plan). Using the set of common transactions, if data of a transaction does not already include role information for a person or entity associated with the transaction, an embodiment determines the role information, using information from a user, directory information obtained from an outside source (e.g. by searching a database or a network making private or public information available, or by analyzing a corpus of natural language text using a natural language processing model), or by using another presently-available technique. For example, if Vendor V previously sent initial proposals to Alice at Company A, Bob at Company B, and Chris at Company C, and Alice, Bob, and Chris are all CIOs of their respective companies, it is logical to conclude that initial proposals are to be sent to the CIO. An embodiment also uses timestamp data for transactions in the set of common transactions to determine the relative timing of transactions. For example, if timestamp data shows that it takes an average of five working days for a customer to respond to an initial proposal, it is logical to conclude that a response to an initial proposal is expected within five working days of proposal receipt. Thus, an embodiment uses one or more action items, corresponding roles, and relative timing between transactions to generate a transaction template.

Once an embodiment has generated one or more transaction templates, the embodiment uses the transaction templates to instantiate new action requests following the templated pattern. For example, in a scenario in which a vendor has already performed several GDPR compliance processes for different customers, and now needs to implement a similar GPDR compliance processes with a new customer, an embodiment uses records of the previous GDPR compliance processes to generate a GDPR compliance process template, then uses the GDPR compliance process template to instantiate a sequence of action requests by which to implement the GDPR compliance process for the new customer.

As part of the instantiation, an embodiment assigns a particular actor to a role specified in the template. The assigned actor will be responsible for the action item specified in the template. To identify an actor for a role, one embodiment uses information from a user. Another embodiment uses directory information obtained from an outside source (e.g. by searching a database or a network making private or public information available). Another embodiment executes a natural language processing model to analyze a corpus of natural language text. Another embodiment uses another presently-available technique.

As part of the instantiation, an embodiment determines a start date for one or more action requests, and uses the start date and a relative time period specified in the template to assign a due date to an action request. For example, if a project is started by sending an initial proposal on April 1, and the relative time period specified in the template for a response is five working days, an embodiment sets a due date for a response to five working days after April 1.

An embodiment administers one or more instantiated action requests. To administer an action request, an embodiment sends the action request to the specified actor or otherwise causes the actor to receive information in the action request. An embodiment also records data of the action request, in a manner described herein. An embodiment is also configurable to send reminders or notify an administrator if an action request is not completed by an assigned due date or if a due date is imminent or about to be missed. In addition, an embodiment is configurable to aggregate multiple action requests assigned to a single actor, to minimize the number of individual action requests directed at the actor.

An embodiment maintains a library of transaction templates. An embodiment uses the library of transaction templates to instantiate additional action requests corresponding to transaction chains that have already been templated. For example, if a vendor needs to implement multiple GPDR compliance processes with a new set of customers, an embodiment uses the GDPR compliance process template to instantiate a sequence of action requests by which to implement the GDPR compliance process for each new customer.

An embodiment uses records of action items generated using a transaction template to adjust the transaction template, adding or removing action items from the template, adjusting role information, and adjusting relative time periods as appropriate. An embodiment also stores the adjusted transaction template in the library for later use.

An embodiment also uses the library of transaction templates to generate new templates, by adding or removing action items or by merging portions of multiple templates. For example a user might specify that a new compliance process includes portions of an already-existing process (e.g. GDPR compliance) but with some steps added or removed. As another example, a user might specify that a new compliance process includes portions of two or more already-existing processes (e.g. GDPR compliance and CCPA compliance). Once a template has been generated, an embodiment stores the new template in the library and uses the template in a manner described herein.

An embodiment also includes a user interface. The user interface allows an administrator to manage a project including instantiating a set of action requests, assigning particular actors to roles, setting a start date or an end date for a sequence of action requests, configuring notification parameters for both an administrator and actor receiving an action request, managing the library of transaction templates, and performing other project management activities.

The manner of template based multi-party process management described herein is unavailable in the presently available methods in the technological field of endeavor pertaining to process management. A method of an embodiment described herein, when implemented to execute on a device or data processing system, comprises substantial advancement of the functionality of that device or data processing system in analyzing data of a set of transactions to generate a transaction template, and uses the transaction template to instantiate a transaction including an action request.

The illustrative embodiments are described with respect to certain types of transactions, records of transactions, groups of transactions, classifications, periods, thresholds, responses, adjustments, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

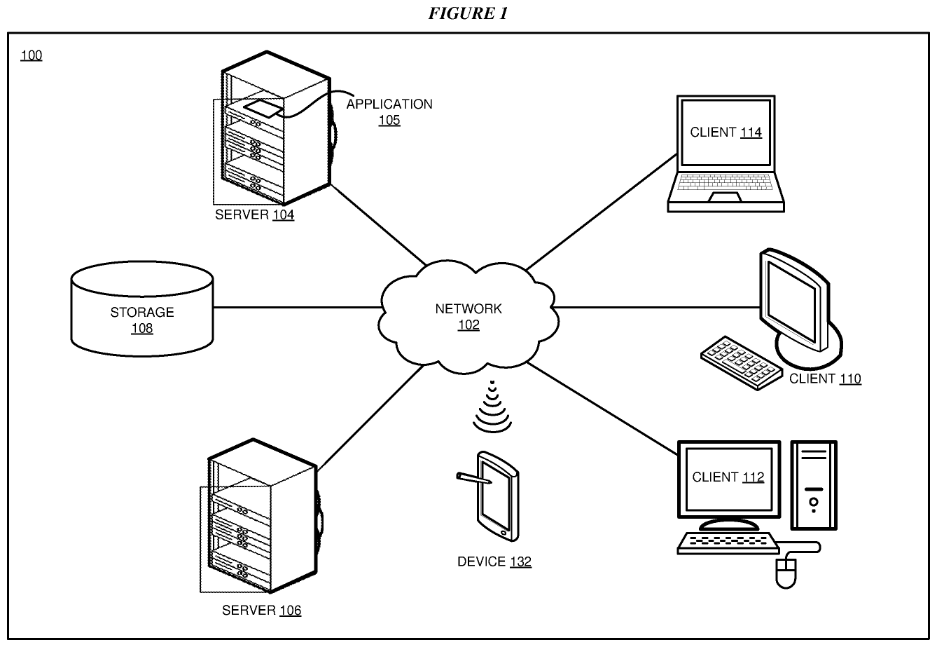

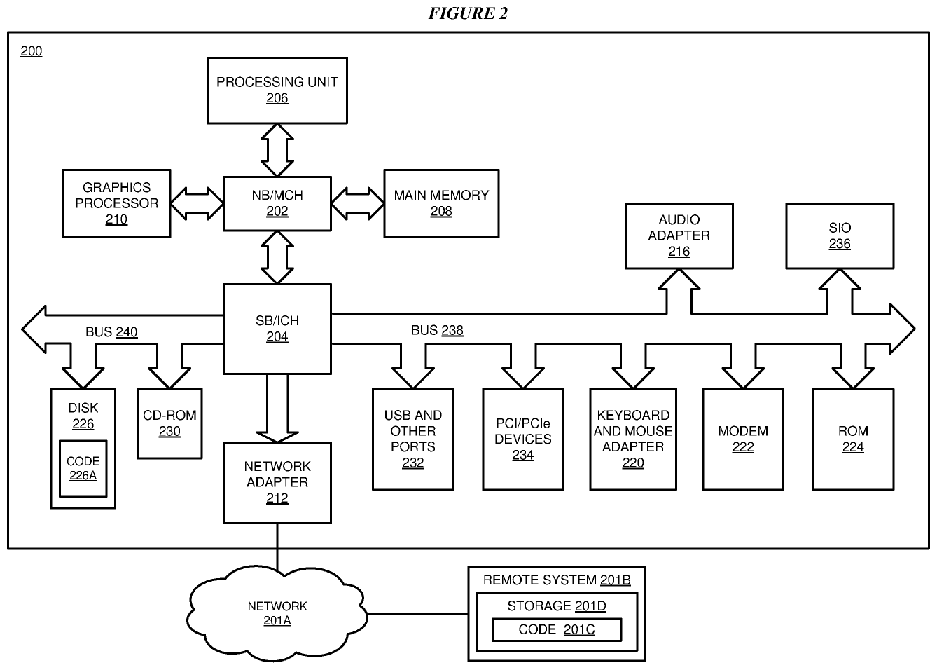

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

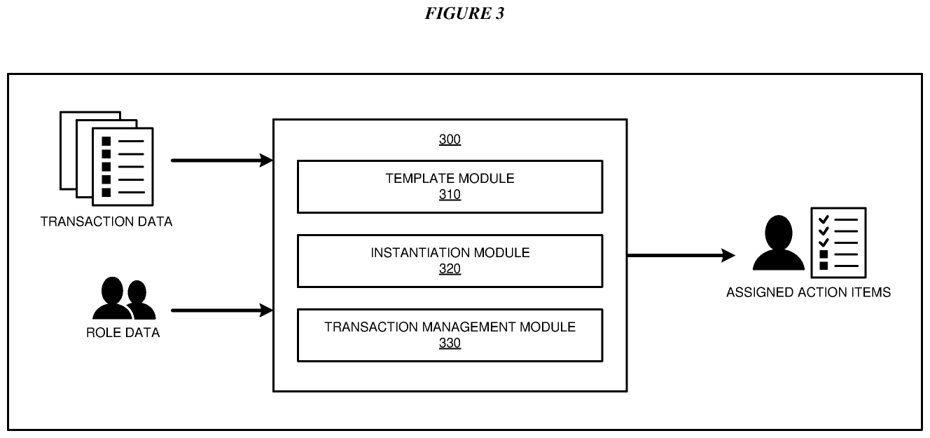

With reference to FIG. 3, this figure depicts a block diagram of an example configuration for template based multi-party process management in accordance with an illustrative embodiment. Application 300 is an example of application 105 in FIG. 1 and executes in any of servers 104 and 106, clients 110, 112, and 114, and device 132 in FIG. 1.

Template module 310 maintains records of transactions or receives transaction records from another source. If necessary, module 310 rearranges the records into chronological order based on data within the transaction records, to form chains of transaction records.

Template module 310 forms chains of transaction records, arranged in time order, into groups based on a possible relationship between individual transactions or transaction chains in the group. Then module 310 compares transaction chains in the group to each other and extracts a set of common transactions. Using the set of common transactions, module 310 classifies a transaction into a transaction type and uses the transaction type as the template's action item. Module 310 also uses the set of common transactions to determines role information corresponding to the action item and uses timestamp data for transactions in the set of common transactions to determine the relative timing of transactions.

Once module 310 has generated one or more transaction templates, instantiation module 320 uses the transaction templates to instantiate new action requests following the templated pattern. As part of the instantiation, module 320 assigns a particular actor to a role specified in the template. The assigned actor will be responsible for the action item specified in the template. To identify an actor for a role, implementations of module 320 use information from a user, directory information obtained from an outside source (e.g. by searching a database or a network making private or public information available), execute a natural language processing model to analyze a corpus of natural language text, or use another presently-available technique. As part of the instantiation, module 320 also determines a start date for one or more action requests, and uses the start date and a relative time period specified in the template to assign a due date to an action request.

Transaction management module 330 administers one or more instantiated action requests. To administer an action request, module 330 sends the action request to the specified actor or otherwise causes the actor to receive information in the action request. Module 330 also records data of the action request, in a manner described herein. Module 330 is also configurable to send reminders or notify an administrator if an action request is not completed by an assigned due date or if a due date is imminent or about to be missed. Module 330 is also configurable to aggregate multiple action requests assigned to a single actor, to minimize the number of individual action requests directed at the actor.

Module 310 maintains a library of transaction templates, and module 320 uses the library of transaction templates to instantiate additional action requests corresponding to transaction chains that have already been templated. Module 310 uses records of action items generated using a transaction template to adjust the transaction template, adding or removing action items from the template, adjusting role information, and adjusting relative time periods as appropriate. Module 310 also uses the library of transaction templates to generate new templates by adding or removing action items or by merging portions of multiple templates.

Application 300 also includes a user interface. The user interface allows an administrator to manage a project including instantiating a set of action requests, assigning particular actors to roles, setting a start date or an end date for a sequence of action requests, configuring notification parameters for both an administrator and actor receiving an action request, managing the library of transaction templates, and performing other project management activities.

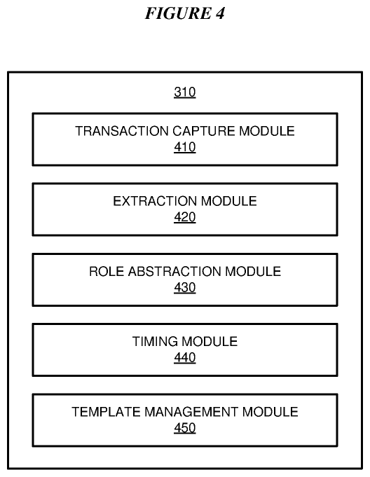

With reference to FIG. 4, this figure depicts a block diagram of an example configuration for template based multi-party process management in accordance with an illustrative embodiment. In particular, FIG. 4 depicts more detail of block 310 in FIG. 3.

Transaction capture module 410 maintains records of transactions or receives transaction records from another source. If the records are not received already in chronological order (i.e. a record with an earlier timestamp comes before a record with a later timestamp), module 410 rearranges the records into chronological order based on data within the transaction records. One implementation of module 410 records transactions in a transaction log implemented in one location. Another implementation of module 410 records transactions in a transaction log implemented in more than one location—also referred to as a distributed transaction log or distributed ledger. In one implementation of module 410, a distributed ledger is implemented using a blockchain.

Extraction module 420 forms chains of transaction records, arranged in time order, into groups based on a possible relationship between individual transactions or transaction chains in the group. Module 420 groups transaction records based on the parties, or the types of parties, involved, based on a description associated with the transaction records, based on time elapsed between transactions, based on another criterion, or based on a combination of criteria.

Module 420 analyzes a group of transaction chains to generate a transaction template. To begin generating the template, module 420 compares transaction chains in the group to each other and extracts a set of common transactions. Using the set of common transactions, if a transaction is not already classified into a transaction type, module 420 classifies the transaction into a transaction type and uses the transaction type as the template's action item.

Using the set of common transactions, if data of a transaction does not already include role information for a person or entity associated with the transaction, role abstraction module 430 determines the role information, using information from a user, directory information obtained from an outside source (e.g. by searching a database or a network making private or public information available, or by analyzing a corpus of natural language text using a natural language processing model), or by using another presently-available technique. Timing module 440 uses timestamp data for transactions in the set of common transactions to determine the relative timing of transactions.

Template management module 450 maintains a library of transaction templates, usable to instantiate additional action requests corresponding to transaction chains that have already been templated. Module 450 uses records of action items generated using a transaction template to adjust the transaction template, adding or removing action items from the template, adjusting role information, and adjusting relative time periods as appropriate. Module 450 also stores the adjusted transaction template in the library for later use.

Module 450 also uses the library of transaction templates to generate new templates by adding or removing action items or by merging portions of multiple templates. Once a template has been generated, module 450 stores the new template in the library and uses the template in a manner described herein.

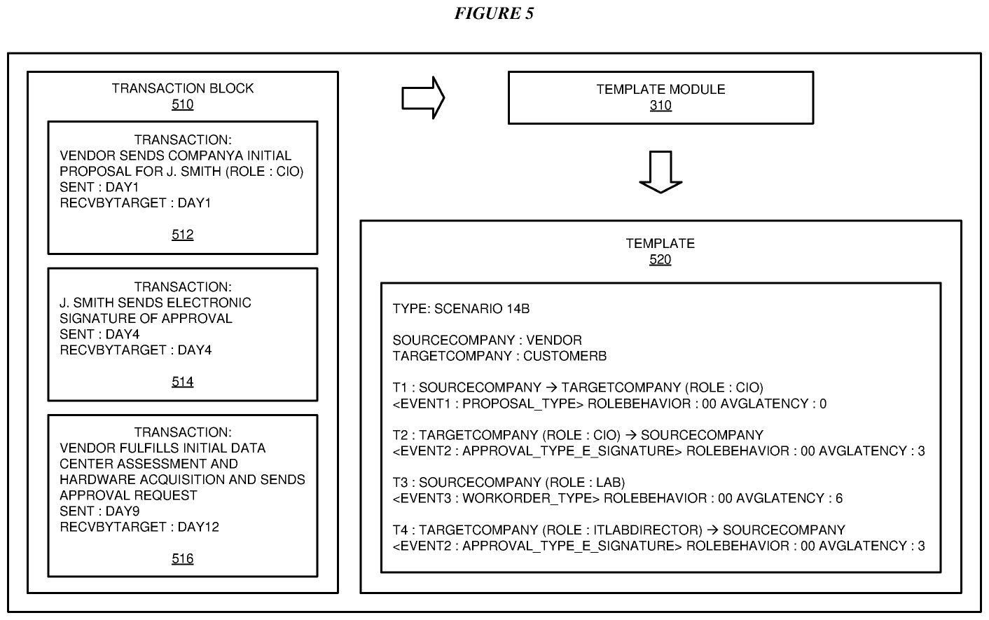

With reference to FIG. 5, this figure depicts an example of template based multi-party process management in accordance with an illustrative embodiment. The example can be executed using application 300 in FIG. 3. Template module 310 is the same as template module 310 in FIG. 3.

Transaction block 510 includes transactions 512, 514, and 516, which have already been grouped together because they are part of a chain that was indicated as being ready for templating. Transaction block 510 depicts related interactions between Vendor and CompanyA. Although transaction block 510 is depicted as including three transactions for ease of illustration, a typical transaction chain would likely be much longer. For example, one common compliance process includes forty transactions. Template module 310 analyzes transaction block 510 to generate template 520, includes one or more action items, such as proposal, approval, and work order, and one or more placeholders for role and relative time data corresponding to each action item.

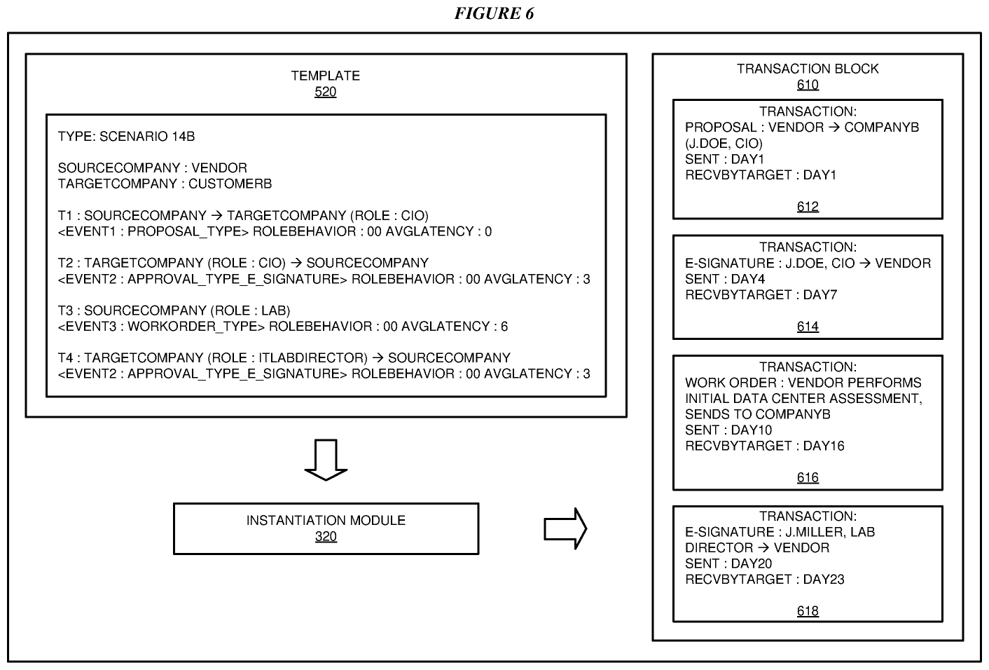

With reference to FIG. 6, this figure depicts a continued example of template based multi-party process management in accordance with an illustrative embodiment. The example can be executed using application 300 in FIG. 3. Instantiation module 320 is the same as instantiation module 310 in FIG. 3. Template 520 is the same as template 520 in FIG. 5.

Once template 520 has been generated, instantiation module 320 uses template 520 to instantiate new action requests following the templated pattern, resulting in transactions 612, 614, 616, and 618 in transaction block 610. As depicted, module 320 has assigned particular actors to roles specified in the template—for example, J. Doe is the CIO at CompanyA, so transaction 612 is sent to J. Doe, and J. Doe responds with a signature in transaction 614. Also as depicted, module 320 has determined a start date for transaction block 610, and used the start date and relative time periods specified in the template to assign due dates to each transaction. For example, if transaction 614 is sent on day 4, and the relative time period specified in the template for a response is 3 days, an embodiment sets a due date for a response to day 7.

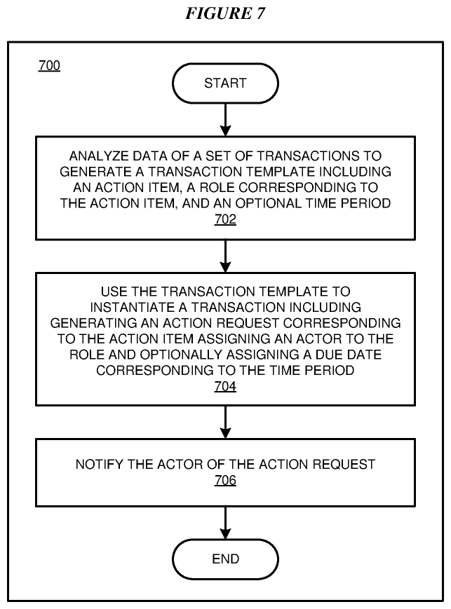

With reference to FIG. 7, this figure depicts a flowchart of an example process for template based multi-party process management in accordance with an illustrative embodiment. Process 700 can be implemented in application 300 in FIG. 3.

In block 702, the application analyzes data of a set of transactions to generate a transaction template including an action item, a role corresponding to the action item, and an optional time period. In block 704, the application uses the transaction template to instantiate a transaction, including generating an action request corresponding to the action item, assigning an actor to the role and optionally assigning a due date corresponding to the time period. In block 706, the application notifies the actor of the action request. Then the application ends.

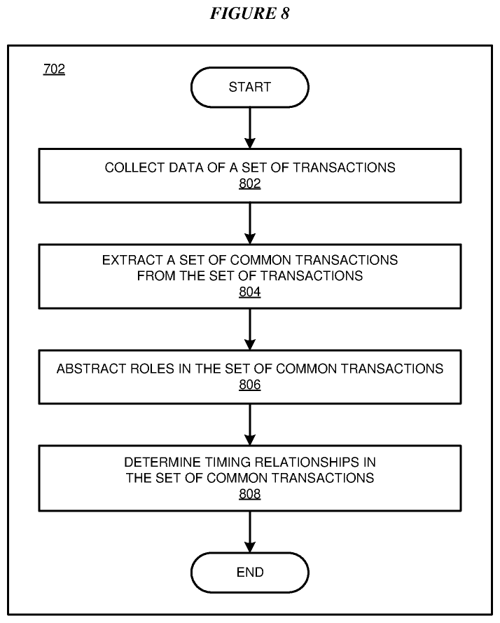

With reference to FIG. 8, this figure depicts a flowchart of an example process for template based multi-party process management in accordance with an illustrative embodiment. Process 800 provides more detail of block 702 in FIG. 7.

In block 802, the application collects data of a set of transactions. In block 804, the application extracts a set of common transactions from the set of transactions. In block 806, the application abstracts roles in the set of common transactions. In block 808, the application determines timing relationships in the set of common transactions. Then the application ends.

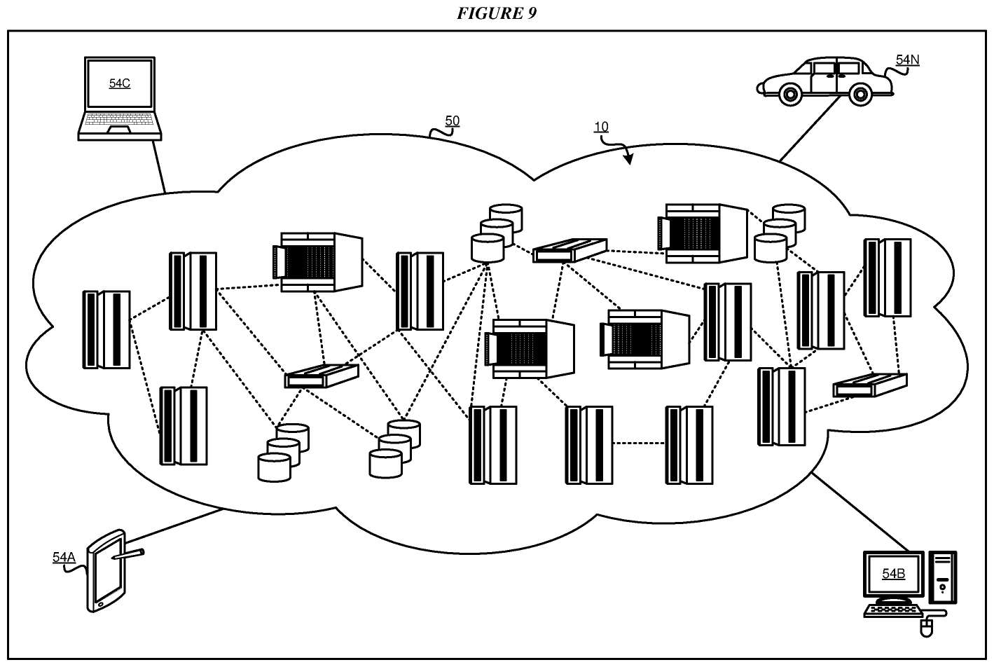

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

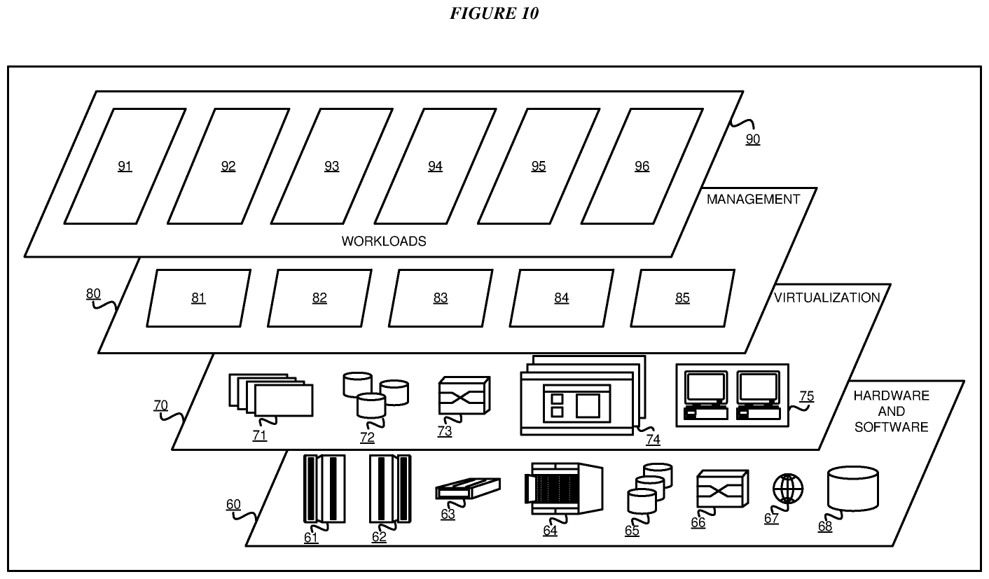

Referring now to FIG. 10, a set of functional abstraction layers provided by cloud computing environment 50 (FIG. 9) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for template based multi-party process management and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
extracting, from a first group of records of a set of transactions, a set of common transactions, the first group formed based on a criterion, a record corresponding to a transaction in the set of transactions;
classifying a first transaction in the set of common transactions into a transaction type;
determining, from a first actor associated with the first transaction, a first role corresponding to the first transaction;
generating, using the transaction type, the first role, and the time period, a transaction template, the transaction template comprising an action item and a role corresponding to the action item; and
instantiating, using the first transaction template, a transaction, the instantiating generating an action request corresponding to the action item and assigning an actor to the role.

2. The computer-implemented method of claim 1, wherein assigning an actor to the role further comprises extracting, from a corpus of narrative text, by executing a natural language processing model, information associating the actor with the role.

3. The computer-implemented method of claim 1, further comprising:
notifying the actor of the action request.

4. The computer-implemented method of claim 1, further comprising:
aggregating, into an aggregated action request, the action request with a second action request assigned to the actor; and
notifying the actor of the aggregated action request.

5. The computer-implemented method of claim 1, further comprising:
determining, from a time elapsed between the first transaction and a second transaction in the set of common transactions, a time period corresponding to the first transaction; and
generating, using the time period, the first transaction template.

6. The computer-implemented method of claim 5, wherein instantiating the transaction further comprises assigning a due date to the action request, the due date corresponding to the time period.

7. The computer-implemented method of claim 6, further comprising:
notifying the actor of the due date.

8. A computer program product for template based multi-party process management, the computer program product comprising:
one or more computer readable storage media, and program instructions collectively stored on the one or more computer readable storage media, the program instructions comprising:
program instructions to extract, from a first group of records of a set of transactions, a set of common transactions, the first group formed based on a criterion, a record corresponding to a transaction in the set of transactions;
program instructions to classify a first transaction in the set of common transactions into a transaction type;
program instructions to determine, from a first actor associated with the first transaction, a first role corresponding to the first transaction;
program instructions to generate, using the transaction type, the first role, and the time period, a transaction template, the transaction template comprising an action item and a role corresponding to the action item; and
program instructions to instantiate, using the first transaction template, a transaction, the instantiating generating an action request corresponding to the action item and assigning an actor to the role.

9. The computer program product of claim 8, wherein program instructions to assign an actor to the role further comprises program instructions to extract, from a corpus of narrative text, by executing a natural language processing model, information associating the actor with the role.

10. The computer program product of claim 8, further comprising:
program instructions to notify the actor of the action request.

11. The computer program product of claim 8, further comprising:
program instructions to aggregate, into an aggregated action request, the action request with a second action request assigned to the actor; and
program instructions to notify the actor of the aggregated action request.

12. The computer program product of claim 8, further comprising:
program instructions to determine, from a time elapsed between the first transaction and a second transaction in the set of common transactions, a time period corresponding to the first transaction; and
program instructions to generate, using the time period, the first transaction template.

13. The computer program product of claim 12, wherein program instructions to instantiate the transaction further comprises program instructions to assign a due date to the action request, the due date corresponding to the time period.

14. The computer program product of claim 13, further comprising:
program instructions to notify the actor of the due date

15. The computer program product of claim 8, wherein the stored program instructions are stored in the at least one of the one or more storage media of a local data processing system, and wherein the stored program instructions are transferred over a network from a remote data processing system.

16. The computer program product of claim 8, wherein the stored program instructions are stored in the at least one of the one or more storage media of a server data processing system, and wherein the stored program instructions are downloaded over a network to a remote data processing system for use in a computer readable storage device associated with the remote data processing system.

17. The computer program product of claim 8, wherein the computer program product is provided as a service in a cloud environment.

18. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to extract, from a first group of records of a set of transactions, a set of common transactions, the first group formed based on a criterion, a record corresponding to a transaction in the set of transactions;
program instructions to classify a first transaction in the set of common transactions into a transaction type;
program instructions to determine, from a first actor associated with the first transaction, a first role corresponding to the first transaction;
program instructions to generate, using the transaction type, the first role, and the time period, a transaction template, the transaction template comprising an action item and a role corresponding to the action item; and
program instructions to instantiate, using the first transaction template, a transaction, the instantiating generating an action request corresponding to the action item and assigning an actor to the role.

19. The computer system of claim 18, wherein program instructions to assign an actor to the role further comprises program instructions to extract, from a corpus of narrative text, by executing a natural language processing model, information associating the actor with the role.

20. The computer system of claim 18, further comprising:
program instructions to notify the actor of the action request.
